(19) United States
(12) Patent Application Publication
(10) Pub. No.: US 2011/0289519 A1
(43) Pub. Date: Nov. 24, 2011

(54) DISTRIBUTING WORKLOADS IN A COMPUTING PLATFORM

(76) Inventor: Gary R. Frost, Driftwood, TX (US)

(21) Appl. No.: 12/785,052

(22) Filed: May 21, 2010

(51) Int. Cl. G06F 9/46; G06F 9/54; G06F 9/455

(52) U.S. Cl. 719/328; 718/105; 718/1

(57) ABSTRACT

Techniques are disclosed relating to distributing workloads between processors. In one embodiment, a computer system includes a first processor and a second processor. The first processor executes program instructions to receive a first set of bytecode specifying a first set of tasks and to determine whether to offload the first set of tasks to the second processor. In response to determining to offload the first set of tasks to the second processor, the program instructions are further executable to cause generation of a set of instructions to perform the first set of tasks, where the set of instructions are in a format different from that of the first set of bytecode, and where the format is supported by the second processor. The program instructions are further executable to cause the second processor to execute the set of instructions by causing the set of instructions to be provided to the second processor.

### BACKGROUND

1. Technical Field

This disclosure relates to computer processors, and, more specifically, to distributing workloads between processors.

2. Description of the Related Art

To improve computational performance, modern processors implement a variety of techniques to perform tasks concurrently. For example, processors are often pipelined and/or multithreaded. Many processors also include multiple cores to further improve performance. Additionally, multiple processors may be included with a single computer system. Some of these processors may be specialized for various tasks, such as graphics processors, digital signal processors (DSPs), etc.

Distributing workloads between all of these different resources can be problematic, particularly when resources have differing interfaces (e.g., code with a first format used for a first processor cannot be used to interface with a second processor, which requires code with a second, different format). Developers who wish to use multiple resources within such a heterogeneous computing platform must thus often write software that includes specific support for each resource. As a result, several “domain-specific” languages have been developed to enable programmers to write software that can help distribute tasks across heterogeneous computing platforms. Such languages include OPENCL, CUDA, DIRECT COMPUTE, etc. Use of these languages may be cumbersome, however.

### SUMMARY

Various embodiments for automatically distributing workloads between processors are disclosed. In one embodiment, a computer-readable storage medium has program instructions stored thereon that are executable on a first processor of a computer system to perform receiving a first set of bytecode, where the first set of bytecode specifies a first set of tasks. The program instructions are further executable to perform causing, in response to determining to offload the first set of tasks to a second processor of the computer system, generation of a set of instructions to perform the first set of tasks. The set of instructions are in a format different from that of the first set of bytecode, where the format is supported by the second processor. The program instructions are further executable to perform causing the set of instructions to be provided to the second processor for execution.

In one embodiment, a computer-readable storage medium includes source program instructions that are compilable by a compiler for inclusion in compiled code as compiled source code. The source program instructions include an application programming interface (API) call to a library routine, where the API call specifies a set of tasks. The library routine is compilable by the compiler for inclusion in the compiled code as a compiled library routine. The compiled source code is interpretable by a virtual machine of a first processor of a computing system to pass the set of tasks to the compiled library routine. The compiled library routine is interpretable by the virtual machine to cause, in response to determining to offload the set of tasks to a second processor of the computer system, generation of a set of domain-specific instructions in a domain-specific language format of the second processor, and to cause the set of domain-specific instructions to be provided to the second processor.

In one embodiment, a computer-readable storage medium includes source program instructions of a library routine that are compilable by a compiler for inclusion in compiled code as a compiled library routine. The compiled library routine is executable on a first processor of a computer system to perform receiving a first set of bytecode, where the first set of bytecode specifies a set of tasks. The compiled library routine is further executable to perform generating, in response to determining to offload the set of tasks to a second processor of the computer system, a set of domain-specific instructions to perform the set of tasks, and causing the domain-specific instructions to be provided to the second processor for execution.

In one embodiment, a method includes receiving a first set of instructions, where the first set of instructions specifies a set of tasks, and where the receiving is performed by a library routine executing on a first processor of a computer system. The method further includes the library routine determining whether to offload the set of tasks to a second processor of the computer system. The method further includes in response to determining to offload the set of tasks to the second processor, causing generation of a second set of instructions to perform the first set of tasks, wherein the second set of instructions are in a format different from that of the first set of instructions, wherein the format is supported by the second processor, and causing the second set of instructions to be provided to the second processor for execution.

In one embodiment, a method includes a computer system receiving a first set of bytecode specifying a set of tasks. The method further includes the computer system generating, in response to determining to offload the set of tasks from a first processor of the computer system to a second processor of the computer system, a set of domain-specific instructions to perform the set of tasks. The method further includes the computer system causing the domain-specific instructions to be provided to the second processor for execution.

### BRIEF DESCRIPTION OF THE DRAWINGS

FIG. 1 is a block diagram illustrating one embodiment of a heterogeneous computing platform configured to convert bytecode to a domain-specific language.

FIG. 2 is a block diagram illustrating one embodiment of a module that is executable to run specified tasks that may be parallelized.

FIG. 3 is a block diagram illustrating one embodiment of a driver that provides domain-specific language support.

FIG. 4 is a block diagram illustrating one embodiment of a determination unit of a module executable to run specified tasks in parallel.

FIG. 5 is a block diagram illustrating one embodiment of an optimization unit of a module executable to run specified tasks in parallel.

FIG. 6 is a block diagram illustrating one embodiment of a conversion unit of a module executable to run specified tasks in parallel.

FIG. 7 is a flow diagram illustrating one embodiment of a method for automatically deploying workloads in a computing platform.

FIG. 8 is a flow diagram illustrating another embodiment of a method for automatically deploying workloads in a computing platform.

FIG. 9 is a block diagram illustrating one embodiment of an exemplary compilation of program instructions.

FIG. 10 is a block diagram illustrating one embodiment of an exemplary computer system.

FIG. 11 is a block diagram illustrating embodiments of exemplary computer-readable storage media.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue.

“Executable.” As used herein, this term refers not only to instructions that are in a format associated with a particular processor (e.g., in a file format that is executable for the instruction set architecture (ISA) of that processor, or is executable in a memory sequence converted from a file, where the conversion is from one platform to another without writing the file to the other platform), but also to instructions that are in an intermediate (i.e., non-source code) format that can be interpreted by a control program (e.g., the JAVA virtual machine) to produce instructions for the ISA of that processor. Thus, the term “executable” encompasses the term “interpretable” as used herein. When a processor is referred to as “executing” or “running” a program or instructions, however, this term is used to mean actually effectuating operation of a set of instructions within the ISA of the processor to generate any relevant result (e.g., issuing, decoding, performing, and completing the set of instructions—the term is not limited, for example, to an “execute” stage of a pipeline of the processor).

“Heterogeneous Computing Platform.” This term has its ordinary and accepted meaning in the art, and includes a system that includes different types of computation units such as a general-purpose processor (GPP), a special-purpose processor (i.e. digital signal processor (DSP) or graphics processing unit (GPU)), a coprocessor, or custom acceleration logic (application-specific integrated circuit (ASIC), field-programmable gate array (FPGA), etc.

“Bytecode.” As used herein, this term refers broadly to a machine-readable representation of compiled source code. In some instances, bytecode may be executable by a processor without any modification. In other instances, bytecode maybe processed by a control program such as an interpreter (e.g., JAVA virtual machine, PYTHON interpreter, etc.) to produce executable instructions for a processor. As used herein, an “interpreter” may also refer to a program that, while not actually converting any code to the underlying platform, coordinates the dispatch of prewritten functions, each of which equates to a single bytecode instruction.

“Virtual Machine.” This term has its ordinary and accepted meaning in the art, and includes a software implementation of a physical computer system, where the virtual machine is executable to receive and execute instructions for that physical computer system.

“Domain-Specific Language.” This term has its ordinary and accepted meaning in the art, and includes a special-purpose programming language designed for a particular application. In contrast, a “general-purpose programming language” is a programming language that is designed for use in a variety of applications. Examples of domain-specific languages include SQL, VERILOG, OPENCL, etc. Examples of general-purpose programming languages include C, JAVA, BASIC, PYTHON, etc.

“Application Programming Interface (API).” This term has its ordinary and accepted meaning in the art, and includes an interface that enables software to interact with other software. A program may make an API call to use functionality of an application, library routine, operating system, etc.

The present disclosure recognizes that there are several drawbacks to using domain-specific languages in the context of computing platforms with heterogeneous resources. Such configurations require software developers to be proficient in multiple programming languages. For example, to interoperate with current JAVA technology, a developer would need to write an OPENCL ‘kernel’ (or method) in OPENCL, write C/C++ code to coordinate execution of this kernel and the JVM and write the Java code to communicate with this C/C++ code using Java's JNI (Java Native Interface) API's. (There are open source pure Java bindings, which will allow one to avoid the C/C++ step but these are not part of the Java language or SDK/JDK.) As a result, developers, who are less familiar with these languages and interfaces, may be reluctant to produce such software. Different versions of software need to be developed for systems that support a domain-specific language and those that do not. Accordingly, a computer system that does not support OPENCL may not be able to run a program that is written in part using OPENCL. Debugging code is also more difficult when source code includes different languages. (Debugging software is generally directed to a specific programming language.) While a user may be able to debug portions of source code, the debugging software may skip over portions of domain-specific code.

Accordingly, the present disclosure provides a mechanism for developers to take advantage of the resources of heterogeneous computing platforms without forcing the developers to use the domain-specific languages normally required to use such resources. In following discussion, embodiments of a mechanism are disclosed for converting bytecode (e.g., from a managed runtime such as JAVA, FLASH, CLR, etc.) to a domain-specific language (such as OPENCL, CUDA, etc.), and for automatically deploying such workloads in a heterogeneous computing platform. As used herein, the term “automatically” means that a task is performed without the need for user input. For example, as will be described below, a set of instructions may be passed to a library routine in one embodiment, where the library routine is executable to automatically determine whether the set of instructions can be offloaded to another processor—here, the term “automatically” means that the library routine performs this determination when requested without a user providing input indicating what the determination should be; instead, the library routine executes to make the determination according to one or more criteria encoded into the library routine.

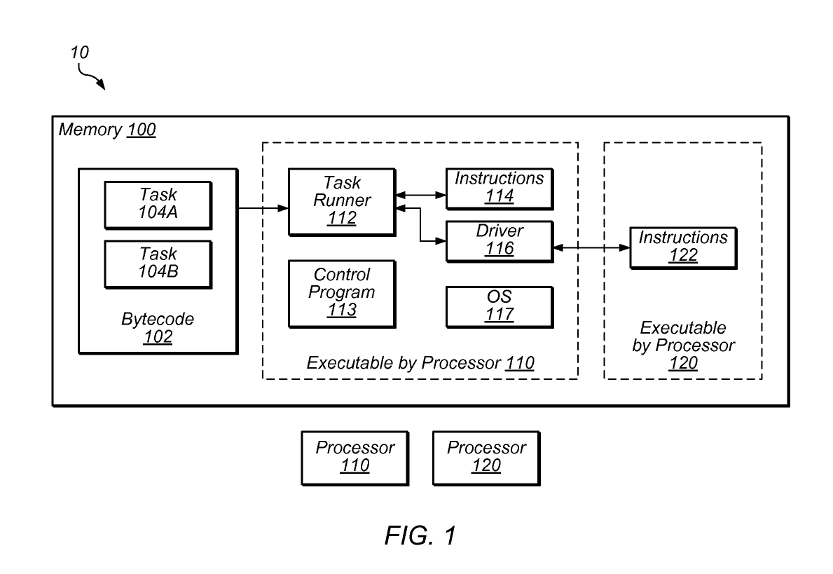

Turning now to FIG. 1, one embodiment of a heterogeneous computing platform 10 configured to convert bytecode to a domain-specific language is depicted. As shown, platform 10 includes a memory 100, processor 110, and processor 120. In the illustrated embodiment, memory 100 includes bytecode 102, task runner 112, control program 113, instructions 114, driver 116, operating system (OS) 117, and instructions 122. In certain embodiments, processor 110 is configured to execute elements 112-117 (as indicated by the dotted line), while processor 120 is configured to execute instructions 122. Platform 10 may be configured differently in other embodiments.

Memory 100, in one embodiment, is configured to store information usable by platform 10. Although memory 100 is shown as a single entity, memory 100, in some embodiments, may correspond to multiple structures within platform 10 that are configured to store various elements such as those shown in FIG. 1. In one embodiment, memory 100 may include primary storage devices such as flash memory, random access memory (RAM-SRAM, EDO RAM, SDRAM, DDR SDRAM, RAMBUS RAM, etc.), read only memory (PROM, EEPROM, etc.). In one embodiment, memory 100 may include secondary storage devices such as hard disk storage, floppy disk storage, removable disk storage, etc. In one embodiment, memory 100 may include cache memory of processors 110 and/or 120. In some embodiments, memory 100 may include a combination of primary, secondary, and cache memory. In various embodiments, memory 100 may includes more (or less) elements than shown in FIG. 1.

Processor 110, in one embodiment, is a general-purpose processor. In one embodiment, processor 110 is a central processing unit (CPU) for platform 10. In one embodiment, processor 110 is a multi-threaded superscalar processor. In one embodiment, processor 110 includes a plurality of multi-threaded execution cores that are configured to operate independently of one another. In some embodiments, platform 10 may include additional processors similar to processor 110. In short, processor 110 may represent any suitable processor.

Processor 120, in one embodiment, is a coprocessor that is configured to execute workloads (i.e., groups of instructions or tasks) that have been offloaded from processor 110. In one embodiment, processor 120 is a special-purpose processor such as a DSP, a GPU, etc. In one embodiment, processor 120 is acceleration logic such as an ASIC, an FPGA, etc. In some embodiments, processor 120 is a multithreaded superscalar processor. In some embodiments, processor 120 includes a plurality of multithreaded execution cores.

Bytecode 102, in one embodiment, is compiled source code. In one embodiment, bytecode 102 may created by a compiler of a general-purpose programming language, such as BASIC, C/C++, FORTRAN, JAVA, PERL, etc. In one embodiment, bytecode 102 is directly executable by processor 110. That is, bytecode 102 may include instructions that are defined within the instruction set architecture (ISA) for processor 110. In another embodiment, bytecode 102 is interpretable (e.g., by a virtual machine) to produce (or coordinate dispatch of) instructions that are executable by processor 110. In one embodiment, bytecode 102 may correspond to an entire executable program. In another embodiment, bytecode 102 may correspond to a portion of an executable program. In various embodiments, bytecode 102 may correspond to one of a plurality of JAVA .class files generated by the JAVA compiler javac for a given program.

In one embodiment, bytecode 102 specifies a plurality of tasks 104A and 104B (i.e., workloads) for parallelization. As will be described below, in various embodiments, tasks 104 may be performed concurrently on processor 110 and/or processor 120. In one embodiment, bytecode 102 specifies tasks 104 by making calls to an application-programming interface (API) associated with task runner 112, where the API allows programmers to represent data parallel problems (i.e., problems that can be performed by executing multiple tasks 104 concurrently) in the same format (e.g., language) used for writing the rest of the source code. For example, in one particular embodiment, a developer writes JAVA source code that specifies a plurality of tasks 104 by extending a base class to encode a data parallel problem, where the base class is defined within the API and bytecode 102 is representative of the extend class. An instance of the extended class may then be provided to task runner 112 to perform tasks 104. In some embodiments, bytecode 102 may specify different sets of tasks 104 to be parallelized (or considered for parallelization).

Task runner 112, in one embodiment, is a module that is executable to determine whether to offload tasks 104 specified by bytecode 102 to processor 120. In one embodiment, bytecode 102 may pass a group of instructions (specifying a task) to task runner 112, which can then determine whether or not to offload the specified group of instructions to processor 120. Task runner 112 may base its determination on a variety of criteria. For example, in one embodiment, task runner 112 may determine whether to offload tasks based, at least in part, on whether driver 116 supports a particular domain-specific language. In one embodiment, if task runner 112 determines to offload tasks 104 to processor 120, task runner 112 causes processor 120 to execute tasks 104 by generating a set of instructions in a domain-specific language that are representative of tasks 104. (As used herein, “domain-specific instructions” are instructions that are written in a domain-specific language). In one embodiment, task runner 112 generates the set of instructions by converting bytecode 102 to domain-specific instructions using metadata contained in a .class file corresponding to bytecode 102. In other embodiments, if the original source code is still available (e.g., as may be the case with BASIC/JAVA/PERL, etc.), task runner 112 may perform a textual conversion of the original source code to domain-specific instructions. In the illustrated embodiment, task runner 112 provides these generated instructions to driver 116, which, in turn, generates instructions 122 for execution by processor 120. In one embodiment, task runner 112 may receive a corresponding set of results for tasks 104 from driver 116, where the results are represented in a format used by the domain-specific language. In some embodiments, after processor 120 has computed the results for a set of tasks 104, task runner 112 is executable to convert the results from the domain-specific language format into a format that is usable by instructions 114. For example, in one embodiment, task runner 112 may convert a set of results from OPENCL datatypes to JAVA datatypes. Task runner 112 may support any of a variety of domain-specific languages, such as OPENCL, CUDA, DIRECT COMPUTE, etc. In one embodiment, if task runner 112 determines to not offload tasks 104, processor 110 executes tasks 104. In various embodiments, task runner 112 may cause the execution of tasks 104 by generating (or causing generation of) instructions 114 for processor 110 that are executable to perform tasks 104. In some embodiments, task runner 112 is executable to optimize bytecode 102 for executing tasks 104 in parallel on processor 110. In some embodiments, task runner 112 may also operate on legacy code. For example, in one embodiment, if bytecode 102 is legacy code, task runner 112 may cause tasks performed by the legacy code to be offloaded to processor 120 or may optimize the legacy code for execution on processor 110.

In various embodiments, task runner 112 is executable to determine whether to offload tasks 104, generate a set of domain-specific instructions, and/or optimize bytecode 102 at runtime—i.e., while a program that includes bytecode 102 is being executed by platform 10. In other embodiments, task runner 112 may determine whether to offload tasks 104 prior to runtime. For example, in some embodiments, task runner 112 may preprocess bytecode 102 for a subsequent execution of a program including bytecode 102.

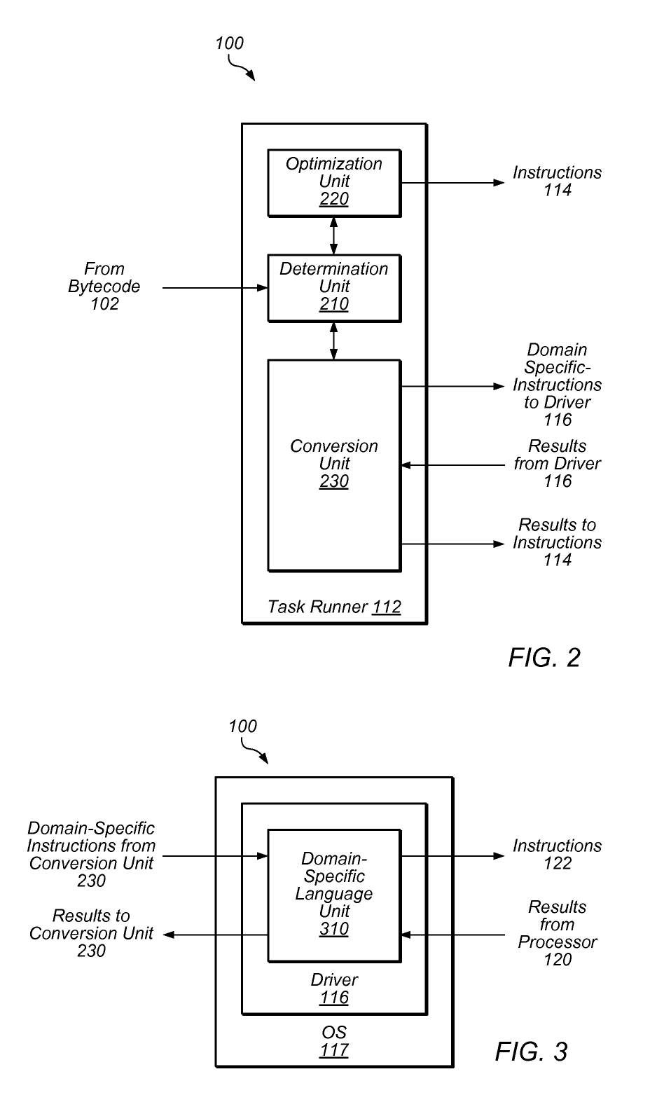

In one embodiment, task runner 112 is a program that is directly executable by processor 110. That is, memory 100 may include instructions for task runner 112 that are defined within the ISA for processor 110. In another embodiment, memory 100 may include bytecode of task runner 112 that is interpretable by control program 113 to produce instructions that are executable by processor 110. Task runner is described in below in conjunction with FIGS. 2 and 4-6.

Control program 113, in one embodiment, is executable to manage the execution of task runner 112 and/or bytecode 102. In some embodiments, control program 113 may manage task runner 112's interaction with other elements in platform 10—e.g., driver 116 and OS 117. In one embodiment, control program 113 is an interpreter that is configured to produce instructions (e.g., instructions 114) that are executable by processor 110 from bytecode (e.g., bytecode 102 and/or bytecode of task runner 112). For example, in some embodiments, if task runner 112 determines to execute a set of tasks on processor 110, task runner 112 may provide portions of bytecode 102 to control program 113 to produce instructions 114. Control program 113 may support any of a variety of interpreted languages, such as BASIC, JAVA, PERL, RUBY, etc. In one embodiment, control program 113 is executable to implement a virtual machine that is configured to implement one or more attributes of a physical machine and to execute bytecode. In some embodiments, control program 113 may include a garbage collector that is used to reclaim memory locations that are no longer being used. Control program 113 may correspond to any of a variety of virtual machines including SUN's JAVA virtual machine, ADOBE's AVM2, MICROSOFT's CLR, etc. In some embodiments, control program 113 may not be included in platform 10.

Instructions 114, in one embodiment, are representative of instructions that are executable by processor 110 to perform tasks 104. In one embodiment, instructions 114 are produced by control program 113 interpreting bytecode 102. As noted above, in one embodiment, instructions may be produced by task runner 112 working in conjunction with control program 113. In another embodiment, instructions 114 are included within bytecode 102. In various embodiments, instructions 114 may include instructions that are executable to operate upon results that have been produced from tasks 104 that have been offloaded to processor 120 for execution. For example, instructions 114 may include instructions that are dependent upon results of various ones of tasks 104. In some embodiments, instructions 114 may include additional instructions generated from bytecode 102 that are not associated with a particular task 104. In some embodiments, instructions 114 may include instructions that are generated from bytecode of task runner 112 (or include instructions from task runner 112).

Driver 116, in one embodiment, is executable to manage the interaction between processor 120 and other elements within platform 10. Driver 116 may correspond to any of a variety of driver types such as graphics card drivers, sound card drivers, DSP card drivers, other types of peripheral device drivers, etc. In one embodiment, driver 116 provides domain-specific language support for processor 120. That is, driver 116 may receive a set of domain-specific instructions and generate a corresponding set of instructions 122 that are executable by processor 120. For example, in one embodiment, driver 116 may convert OPENCL instructions for a given set of tasks 104 into ISA instructions of processor 120, and provide those ISA instructions to processor 120 to cause execution of the set of tasks 104. Driver 116 may, of course, support any of a variety of domain-specific languages. Driver 116 is described further below in conjunction with FIG. 3.

OS 117, in one embodiment, is executable to manage execution of programs on platform 10. OS 117 may correspond to any of a variety of known operating systems such as LINUX, WINDOWS, OSX, SOLARIS, etc. In some embodiments, OS 117 may be part of a distributed operation system. In various embodiments, OS may include a plurality of drivers to coordinate the interactions of software on platform 10 with one or more hardware components of platform 10. In one embodiment, driver 116 is integrated within OS 117. In other embodiments, driver 116 is not a component of OS 117.

Instructions 122, in one embodiment, represent instructions that are executable by processor 120 to perform tasks 104. As noted above, in one embodiment, instructions 122 are generated by driver 116. In another embodiment, instructions 122 may be generated differently—e.g., by task runner 112, control program 113, etc. In one embodiment, instructions 122 are defined within the ISA for processor 120. In another embodiment, instructions 122 may be commands that are used by processor 120 to generate a corresponding set of instructions that are executable by processor 120.

In various embodiments, platform 10 provides a mechanism that enables programmers to develop software that uses multiple resources of platform 10—e.g., processors 110 and 120. In some instances, a programmer may write software using a single general-purpose language (e.g., JAVA) without having an understanding of a particular domain-specific language—e.g., OPENCL. Since software can be written using the same language, a debugger that supports the language (e.g., the GNU debugger debugging JAVA via the ECLIPSE IDE) can debug an entire piece of software including the portions that make API calls to perform tasks 104. In some instances, a single version of software can be written for multiple platforms regardless of whether these platforms provide support for a particular domain-specific language, since task runner 112, in various embodiments, is executable to determine whether to offload tasks at runtime and can determine whether such support exists on a given platform 10. If, for example, platform 10 is unable to offload tasks 104, task runner 112 may still be able to optimize a developer's software so that it executes more efficiently. In fact, task runner 112, in some instances, may be better at optimizing software for parallelization than if the developer had attempted to optimize the software on his/her own.

Turning now to FIG. 2, a representation of one embodiment of a task runner software module 112 is depicted. As noted, task runner 112 is code (or memory storing such code) that is executable to receive a set of instructions (e.g., those assigned to processor 110) and determine whether to offload (i.e., reassign) those instructions to a different processor (e.g., processor 120). As shown, task runner 112 includes a determination unit 210, optimization unit 220, and conversion unit 230. In one embodiment, control program 113 (not shown in FIG. 2) is a virtual machine in which task runner 112 executes. For example, in one embodiment, control program 113 corresponds to the JAVA virtual machine, where task runner 112 is interpreted JAVA bytecode. In other embodiments, processor 110 may execute task runner 112 without using control program 113.

Determination unit 210, in one embodiment, is representative of program instructions that are executable to determine whether to offload tasks 104 to processor 120. In the illustrated embodiment, task runner 210 includes execution of instructions in determination unit 210 in response to receiving bytecode 102 (or at least a portion of bytecode 102). In one embodiment, task runner 210 initiates execution of instructions in determination unit 210 in response to receiving a JAVA .class file that includes bytecode 102.

In one embodiment, determination unit 210 may include instructions executable to determine whether to offload tasks based on a set of one or more initial criteria associated with properties of platform 10 and/or an initial analysis of bytecode 102. In various embodiments, such determination is automatic. In one embodiment, determination unit 210 may execute to make an initial determination based, at least in part, on whether platform 10 supports domain-specific language(s). If support does not exist, determination unit 210, in various embodiments, may not perform any further analysis. In some embodiments, determination unit 210 determines whether to offload tasks 104, based at least in part, on whether bytecode 102 references datatypes or calls methods that cannot be represented in a domain-specific language. For example, a particular domain-specific language may not support IEEE double-precision datatypes. Therefore, determination unit 210 may determine to not offload a JAVA workload that includes doubles. Similarly, JAVA supports the notion of a String datatype (actually a Class), which unlike most classes is understood by the JAVA virtual machine, but has no such representation in OPENCL. As a result, determination unit 210, in one embodiment, may determine that a JAVA workload referencing to such String datatypes is not be offloaded. In other embodiment, determination unit 210 may perform further analysis to determine if the uses of String might be ‘mappable’ to other OPENCL representable types—e.g., if String references can be removed and replaced by other code representations. In one embodiment, if a set of initial criteria is satisfied, task runner 112 may initiate execution of instructions in conversion unit 230 to convert bytecode 102 into domain-specific instructions.

In one embodiment, determination unit 210 continues to execute, based on an additional set of criteria, to determine whether to offload tasks 104 while conversion unit 230 executes. For example, in one embodiment, determination unit 210 determines whether to offload tasks 104 based, at least in part, on whether bytecode 102 is determined to have an execution path that results in an indefinite loop. In one embodiment, determination unit 210 determines to offload tasks 104 based, at least in part, on whether bytecode 102 attempts to perform an illegal action such as using recursion.

Additionally, determination unit 210 may also execute to determine whether to offload tasks 104 based, at least in part, on one or more previous executions of a set of tasks 104. For example, in one embodiment, determination unit 210 may store information about previous determinations for sets of tasks 104, such as indication of whether a particular set of tasks 104 was offloaded successfully. In some embodiments, determination unit 210 determines whether to offload tasks 104 based, at least in part, on whether task runner 112 stores a set of previously generated domain-specific instruction for that set of tasks 104. In various embodiments, determination unit 210 may collect information about previous iterations of a single portion of bytecode 102—e.g., where the portion of bytecode 102 specifies the same set of tasks 104 multiple times, as in a loop. Alternatively, determination unit 210 may collect information about previous executions that resulted from executing a program that includes bytecode 102 multiple times in different parts of a program. In one embodiment, determination unit 210 may collect information about the efficiency of pervious executions of tasks 104. For example, in some embodiments, task runner 112 may cause tasks 104 to be executed by processor 110 and by processor 120. If determination unit 210 determines that processor 110 executed the set of tasks more efficiently (e.g., using less time) than processor 120, determination unit 210 may determine to not offload subsequent executions of tasks 104. Alternately, if determination unit 210 determines that processor 120 is more efficient in executing the set of tasks, unit 210 may, for example, cache an indication to offload subsequent executions of the set of tasks.

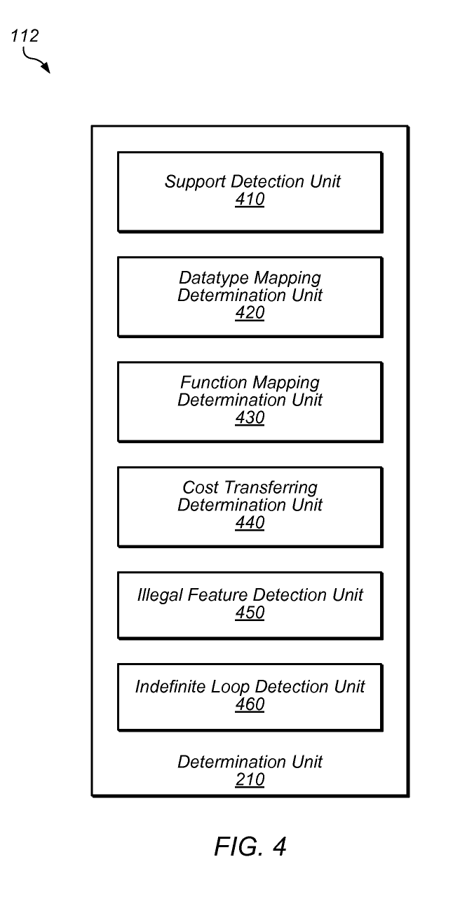

Determination unit 210 is described below further in conjunction with FIG. 4.

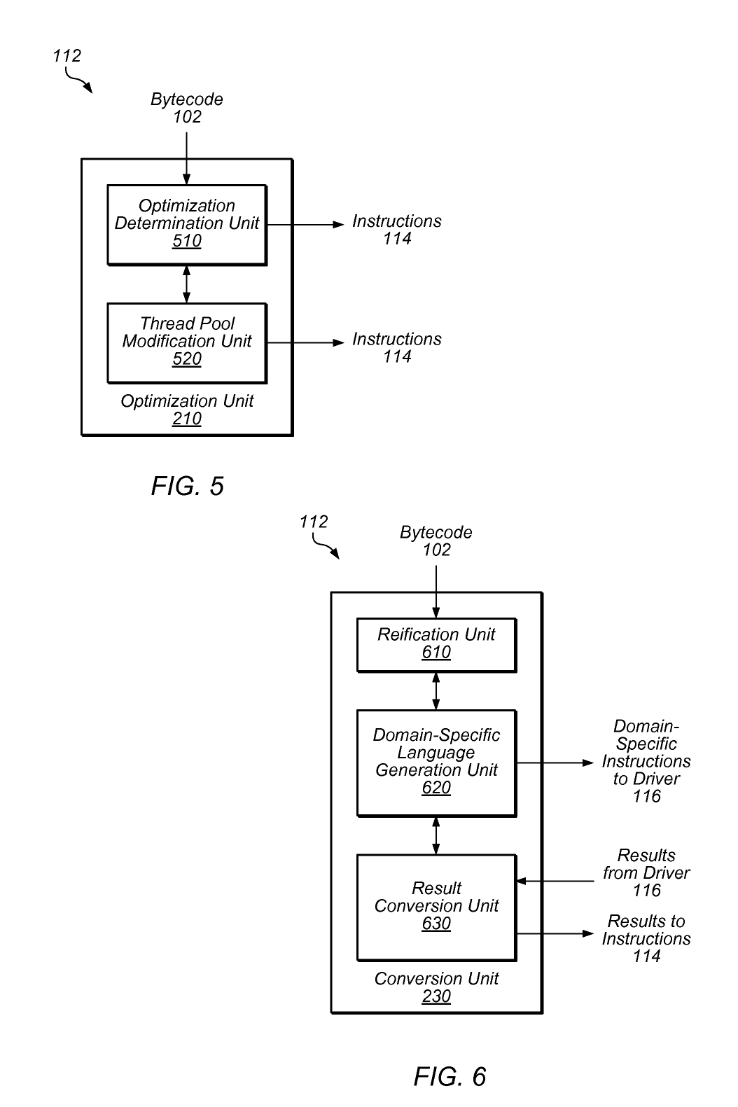

Optimization unit 220, in one embodiment, is representative of program instructions that are executable to optimize bytecode 102 for execution of tasks 104 on processor 110. In one embodiment, task runner 112 may initiate execution of optimization unit 220 once determination unit 210 determines to not offload tasks 104. In various embodiments, optimization unit 220 analyzes bytecode 102 to identify portions of bytecode 102 that can be modified to improve parallelization. In one embodiment, if such portions are identified, optimization unit 220 may modify bytecode 102 to add thread pool support for tasks 104. In other embodiments, optimization unit 220 may improve the performance of tasks 104 using other techniques. Once portions of bytecode 102 have modified, optimization unit 220, in some embodiments, provides the modified bytecode 102 to control program 113 for interpretation into instructions 114. Optimization of bytecode 102 is described further below in conjunction with FIG. 5.

Conversion unit 230, in one embodiment, is representative of program instructions that are executable to generate a set of domain-specific instructions for execution of tasks 104 on processor 120. In one embodiment, execution of task runner 112 may include initiation of execution of conversion unit 230 once determination unit 210 determines that a set of initial criteria has been satisfied for offloading tasks 104. In the illustrated embodiment, conversion unit 230 provides a set of domain-specific instructions to driver 116 to cause processor 120 to execute tasks 104. In one embodiment, conversion unit 230 may receive a corresponding set of results for tasks 104 from driver 116, where the results are represented in a format of the domain-specific language. In some embodiments, conversion unit 230 converts the results from the domain-specific language format into a format that is usable by instructions 114. For example, in one embodiment, after task runner 112 has received a set of computed results from driver 116, task runner 112 may convert a set of results from OPENCL datatypes to JAVA datatypes. In one embodiment, task runner 112 (e.g., conversion unit 230) is executable to store a generated set of domain-specific instructions for subsequent executions of tasks 104. In some embodiments, conversion unit 230 generates a set of domain-specific instructions by converting bytecode 102 to an intermediate representation and then generating the set of domain-specific instructions from the intermediate representation. Converting bytecode 102 to a domain-specific language is described below further in conjunction with FIG. 6.

Note that units 210, 220, and 230 are exemplary; in various embodiments of task runner 112, instructions may be grouped differently.

Turning now to FIG. 3, one embodiment of driver 116 is depicted. As shown, driver 116 includes a domain-specific language unit 310. In the illustrated embodiment driver 116 is incorporated within OS 117. In other embodiments, driver 116 may be implemented separately from OS 117.

Domain-specific language unit 310, in one embodiment, is executable to provide driver support for domain-specific language(s). In one embodiment, unit 310 receives a set of domain-specific instructions from conversion unit 230 and produces a corresponding set of instructions 122. In various embodiments, unit 310 may support any of a variety of domain-specific languages such as those described above. In one embodiment, unit 310 produces instructions 122 that are defined within the ISA for processor 120. In another embodiment, unit 310 produces non-ISA instructions that cause processor 120 to execute tasks 104—e.g., processor 120 may use instructions 122 to generate a corresponding set of instructions that are executable by processor 120.

Once processor 120 executes a set of tasks 104, domain-specific language unit 310, in one embodiment, receives a set of results and converts those results into datatypes of the domain-specific language. For example, in one embodiment, unit 310 may convert received results into OPENCL datatypes. In the illustrated embodiment, unit 310 provides the converted results to conversion unit 230, which, in turn, may convert the results from datatypes of the domain-specific language into datatypes supported by instructions 114—e.g., JAVA datatypes.

Turning now to FIG. 4, one embodiment of determination unit 210 is depicted. In the illustrated embodiment, determination unit 210 includes a plurality of units 410-460 for performing various tests on received bytecode 102. In other embodiments, determination unit 210 may include additional units, fewer units, or different units from those shown. In some embodiments, determination unit 210 may perform various of the depicted tests in parallel. In one embodiment, determination unit 210 may test various ones of the criteria at different stages during the generation of domain-specific instructions from bytecode 102.

Support detection unit 410, in one embodiment, is representative of program instructions that are executable to determine whether platform 10 supports domain-specific language(s). In one embodiment, unit 410 determines that support exists based on information received from OS 117—e.g., system registers. In another embodiment, unit 410 determines that support exists based on information received from driver 116. In other embodiments, unit 410 determines that support exists based on information from other sources. In one embodiment, if unit 410 determines that support does not exist, determination unit 210 may conclude that tasks 104 cannot be offloaded to processor 120.

Datatype mapping determination unit 420, in one embodiment, is representative of program instructions that are executable to determine whether bytecode 102 references any datatypes that cannot be represented in the target domain-specific language—i.e., the domain-specific language supported by driver 116. For example, if bytecode 102, in one embodiment, is JAVA bytecode, datatypes, such as int, float, double, byte, or arrays of such primitives, may have corresponding datatypes in OPENCL. In one embodiment, if unit 420 determines that bytecode 102 references datatypes that cannot be represented in the target domain-specific language for a set of tasks 104, determination unit 210 may determine to not offload that set of tasks 104.

Function mapping determination unit 430, in one embodiment, is representative of program instructions that are executable to determine whether bytecode 102 calls any functions (e.g., routines/methods) that are not supported by the target domain-specific language. For example, if bytecode 102 is JAVA bytecode, unit 430 may determine whether the JAVA bytecode invokes a JAVA specific function (e.g., System.out.println) for which there is no equivalent in OPENCL. In one embodiment, if unit 430 determines that bytecode 102 calls unsupported functions for a set of tasks 104, determination unit 210 may determine to abort offloading the set of tasks 104. On the other hand, if bytecode code 102 calls only those functions that are supported in the target domain-specific language (e.g., JAVA's Math.sqrt( ) function which is compatible with OPENCL's sqrt( ) function), determination unit 210 may allow offloading to continue.]

Cost transferring determination unit 440, in one embodiment, is representative of program instructions that are executable to determine whether the group size of a set of tasks 104 (i.e., number of parallel tasks) is below a predetermined threshold—indicating that the cost of offloading is unlikely to be cost effective. In one embodiment, if unit 440 determines that the group size is below the threshold, determination unit 210 may determine to abort offloading the set of tasks 104. Unit 440 may perform various other checks to compare an expected benefit of offloading to an expected cost.

Illegal feature detection unit 450, in one embodiment, is representative of program instructions that are executable to determine whether bytecode 102 is using a feature that is syntactically acceptable but illegal. For example, in various embodiments, driver 116 may support a version of OPENCL that forbids methods/functions to use recursion (e.g., that version does not have a way to represent stack frames required for recursion). In one embodiment, if unit 450 determines that JAVA code may perform recursion, then determination unit 210 may determine to not deploy that JAVA code as this may result in an unexpected runtime error. In one embodiment, if unit 450 detects such usage for a set of tasks 104, determination unit 210 may determine to abort offloading.

Indefinite loop detection unit 460, in one embodiment, is representative of program instructions that are executable to determine whether bytecode 102 has any paths of execution that may possibly loop indefinitely—i.e., result in an indefinite/infinite loop. In one embodiment, if unit 460 detects any such paths associated with a set of tasks 104, determination unit 210 may determine to abort offloading the set of tasks 104.

As noted above, determination unit 210 may test various criteria at different stages during the conversion process of bytecode 102. If, at any point, one of the tests fails for a set of tasks, determination unit 210, in various embodiments, can immediately determine to abort offloading. By testing criteria in this manner, determination unit 210, in some instances, can quickly arrive at a determination to abort offloading before expending significant resources on the conversion of bytecode 102.

Turning now to FIG. 5, one embodiment of optimization unit 220 is depicted. In one embodiment, task runner 112 may initiate execution of optimization unit 220 in response to determination unit 210 determining to abort offloading of a set of tasks 104. In another embodiment, task runner 112 may initiate execution of optimization unit 220 in conjunction with the conversion unit 230—e.g., before determination unit 210 has determined whether to abort offloading. In the illustrated embodiment, optimization unit 220 includes optimization determination unit 510 and thread pool modification unit 520. In some embodiments, optimization unit 220 includes additional units for optimizing bytecode 102 using other techniques.

Optimization determination unit 510, in one embodiment, is representative of program instructions that are executable to identify portions of bytecode 102 that can be modified to improve execution of tasks 104 by processor 110. In one embodiment, unit 510 may identify portions of bytecode 102 that include calls to an API associated with task runner 112. In one embodiment, unit 510 may identify particular structural elements (e.g., loops) in bytecode 102 for parallelization. In one embodiment, unit 510 may identify portions by analyzing an intermediate representation of bytecode 102 generated by conversion unit 230 (described below in conjunction with FIG. 6). In one embodiment, if unit 510 determines that portions of bytecode 102 can be modified to improve the performance of a set of tasks 104, optimization unit 210 may initiate execution of thread pool modification unit 520. If unit 510 determines that portions of bytecode 102 cannot be improved via predefined mechanisms, unit 510, in one embodiment, provides those portions to control program 113 without any modification, thus causing control program 113 to produce corresponding instructions 114.

Thread pool modification unit 520, in one embodiment, is representative of program instructions that are executable to add support for creating a thread pool that is used by processor 110 to execute tasks 104. For example, in various embodiments, unit 520 may modify bytecode 102 in preparation of executing the data parallel workload on the originally targeted platform (e.g., processor 110) assuming that no offload was possible. Thus, by using task runner 112 and providing a base class that is extendable by a programmer, the programmer can declare that the code is intended to be parallelized (e.g., executing in an efficient data parallel manner). In a JAVA environment, this means the default JAVA implementation of task runner 112 may use a thread pool by coordinating the execution of the code without transforming it. If the code is offloadable then it is assumed that the platform to which the code is offloaded coordinates parallel execution. As used herein, a “thread pool” is a queue that includes a plurality of threads for execution. In one embodiment, a thread may be created for each task 104 in a given set of tasks. When a thread pool is used, a processor (e.g., processor 110) removes threads from the pool as resources become available to execute those threads. Once a thread completes execution, the results of the thread's execution, in some embodiments, are placed in the corresponding queue until the results can be used.

Consider the situation in which bytecode 102 specifies a set of 2000 tasks 104. In one embodiment, unit 520 may add support to bytecode 102 so that it is executable to create a thread pool that includes 2000 threads—one for each task 104. In one embodiment, if processor 110 is a quad-core processor, each core can execute 500 of the tasks 104. If each core can execute 4 threads at a time, 16 threads can be executed concurrently. Accordingly, processor 110 can execute a set of tasks 104 significantly faster than if tasks 104 were executed sequentially.

Turning now to FIG. 6, one embodiment of a conversion unit 230 is depicted. As noted above, in one embodiment, task runner 112 may initiate execution of conversion unit 230 in response to determination unit 210 determining that a set of initial criteria for offloading a set of tasks 104 has been satisfied. In another embodiment, task runner 112 may initiate execution of conversion unit 230 in conjunction with the optimization unit 220. In the illustrated embodiment, conversion unit 230 includes reification unit 610, domain-specific language generation unit 620, and result conversion unit 630. In other embodiments, conversion unit 230 may be configured differently.

Reification unit 610, in one embodiment, is representative of program instructions that are executable to reify bytecode 102 and produce an intermediate representation of bytecode 102. As used herein, reification refers to the process of decoding bytecode 102 to abstract information included therein. In one embodiment, unit 610 begins by parsing bytecode 102 to identify constants that are used during execution. In some embodiments, unit 610 identifies constants in bytecode 102 by parsing the constant_pool portion of a JAVA .class file for constants such as integers, Unicode, strings, etc. In some embodiments, unit 610 also parses the attribute portion of the .class file to reconstruct attribute information usable to produce the intermediate representation of bytecode 102. In one embodiment, unit 610 also parses bytecode 102 to identify any method used by bytecode. In some embodiments, unit 610 identifies methods by parsing the methods portion of a JAVA .class file. In one embodiment, once unit 610 has determined information about constants, attributes, and/or methods, unit 610 may begin decode instructions in bytecode 102. In some embodiments, unit 610 may produce the intermediate representation by constructing an expression tree from the decoded instructions and parsed information. In one embodiment, after unit 610 completes adding information to the expression tree, unit 610 identifies higher-level structures in bytecode 102, such as loops, nested if statements, etc. In one embodiment, unit 610 may identify particular variables or arrays that are known to be read by bytecode 102. Additional information about reification can be found in “A Structuring Algorithm for Decompilation (1993)” by Cristina Cifuentes.

Domain-specific language generation unit 620, in one embodiment, is representative of program instructions that are executable to generate domain-specific instructions from the intermediate representation generated by reification unit 610. In one embodiment, unit 620 may generate domain-specific instructions that include corresponding constants, attributes, or methods identified in bytecode 102 by reification unit 610. In some embodiments, unit 620 may generate domain-specific instructions that have corresponding higher-level structures to those in bytecode 102. In various embodiments, unit 620 may generate domain-specific instructions based on other information collected by reification unit 610. In some embodiments, if reification unit 610 identifies particular variables or arrays that are known to be read by bytecode 102, unit 620 may generate domain-specific instructions to place the arrays/values in ‘READ ONLY’ storage or to mark the arrays/values as READ ONLY in order to allow code optimization. Similarly, unit 620 may generate domain-specific instructions to tag values as WRITE ONLY or READ WRITE.

Results conversion unit 630, in one embodiment, is representative of program instructions that are executable to convert results for tasks 104 from a format of a domain-specific language to a format supported by bytecode 102. For example, in one embodiment, unit 630 may convert results (e.g., integers, booleans, floats, etc.) from an OPENCL datatype format to a JAVA datatype format. In some embodiments, unit 630 converts results by copying data to a data structure representation that is held by the interpreter (e.g., control program 113). In some embodiments, unit 630 may change data from a big-endian representation to little-endian representation. In one embodiment, task runner 112 reserves a set of memory locations to store the set of results generated from the execution of a set of tasks 104. In some embodiments, task runner 112 may reserve the set of memory locations before domain-specific language generation unit 620 provides domain-specific instructions to driver 116. In one embodiment, unit 630 prevents the garbage collector of control program 113 from reallocating the memory locations while processor 120 is producing the results for the set of tasks 104. That way, unit 630 can store the results in the memory location upon receipt from driver 116.

Various methods that employ the functionality of units described above are presented next.

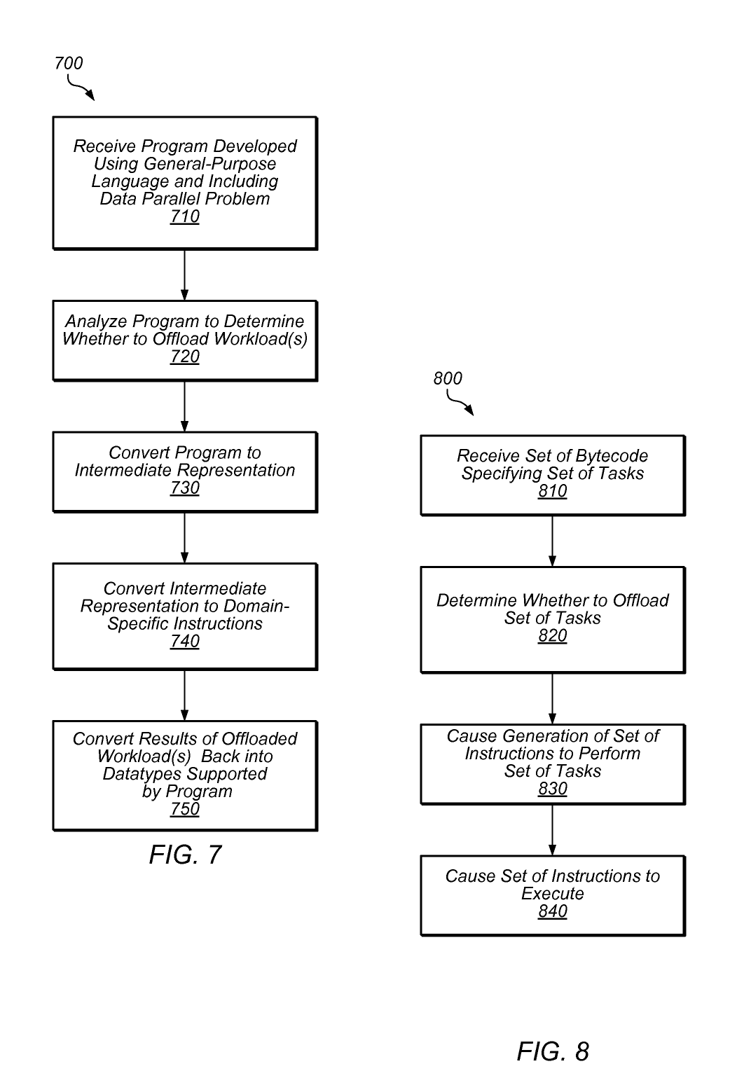

Turning now to FIG. 7, one embodiment of a method 700 for automatically deploying workloads in a computing platform is depicted. In one embodiment, platform 10 performs method 700 to offload workloads (e.g., tasks 104) specified by a program (e.g., bytecode 102) to a coprocessor (e.g., processor 120). In some embodiments, platform 10 performs method 700 by executing program instructions (e.g., on processor 110) that are generated by a control program (e.g., control program 113) interpreting bytecode (e.g., of task runner 112). In the illustrated embodiment, method 700 includes steps 710-750. Method 700 may include additional (or fewer) steps in other embodiments. Various ones of steps 710-750 may be performed concurrently, at least in part.

In step 710, platform 10 receives a program (e.g., corresponding to bytecode 102 or including bytecode 102) that is developed using a general-purpose language and that includes a data parallel problem. In some embodiments, the program may have been developed in JAVA using an API that allows a developer to represent the data parallel problem by extending a base class defined within the API. In other embodiments, the program may be developed using a different language, such as the ones described above. In other embodiments, the data parallel problem may be represented using other techniques. In one embodiment, the program may be interpretable bytecode—e.g., that is interpreted by control program 113. In another embodiment, the program may be executable bytecode that is not interpretable.

In step 720, platform 10 analyzes (e.g., using determination unit 210) the program to determine whether to offload one or more workloads (e.g., tasks 104)—e.g., to a coprocessor such as processor 120 (the term “coprocessor” is used to denote a processor other than the one that is executing method 800). In one embodiment, platform 10 may analyze a JAVA .class file of the program to determine whether to perform the offloading. Platform 10's determination may be various combinations of the criteria described above. In one embodiment, platform 10 makes an initial determination based on a set of initial criteria. In some embodiments, if each of the initial criteria is satisfied, method 700 may proceed to steps 730 and 740. In one embodiment, platform 10 may continue to determine whether to offload workloads, while steps 730 and 740 are being performed, based on various additional criteria. In various embodiments, platform 10's analysis may be based on cached information for previously offloaded workloads.

In step 730, platform 10 converts (e.g., using conversion unit 230) the program to an intermediate representation. In one embodiment, platform 10 converts the program by parsing a JAVA .class file of the program to identify constants, attributes, and/or methods used by the program. In some embodiments, platform 10 decodes instructions in the program to identify higher-level structures in the program such as loops, nested if statements, etc. In some embodiments, platform 10 creates an expression tree to represent the information collected by reifying the program. In various embodiments, platform 10 may use any of the various techniques described above. In some embodiments, this intermediate representation may be analyzed to further to determine whether to offload workloads.

In step 740, platform 10 converts (e.g., using conversion unit 230) the intermediate representation to a domain-specific language. In one embodiment, platform 10 generates domain-specific instruction (e.g., OPENCL) instructions based on information collected in step 730. In some embodiments, platform 10 generates the domain-specific instructions from an expression-tree constructed in step 730. In one embodiment, platform 10 provides the domain-specific instructions to a driver of the coprocessor (e.g., driver 116 of processor 120) to cause the coprocessor to execute the offloaded workloads.

In step 750, platform 10 converts (e.g., using conversion unit 230) the results of the offloaded workloads back into datatypes supported by the program. In one embodiment, platform 10 converts the results from an OPENCL datatypes back into JAVA datatypes. Once the results have been converted, instructions of the program may be executed that use the converted results. In one embodiment, platform 10 may allocate memory locations to store results before providing the domain-specific instructions to the driver of the coprocessor. In some embodiments, platform 10 may prevent these locations from being reclaimed by a garbage collector of the control program while the coprocessor is producing the results.

It is noted that method 700 may be performed multiple times for different received programs. Method 700 may also be repeated if the same program (e.g., set of instructions) is received again. If the same program is received twice, various ones of steps 710-750 may be omitted. As noted above, in some embodiments, platform 10 may cache information about previously offloaded workloads such as information generated during steps 720-740. If program is received again, platform 10, in one embodiment, may perform a cursory determination in step 720, such as determining whether the workloads were previously offloaded successfully. In some embodiments, platform 10 may then use previously cached domain-specific instructions instead of performing steps 730-740. In some embodiments in which the same set of instructions is received again, step 750 may still be performed in a similar manner as described above.

Various steps of method 700 may also be repeated if a program specifies that a set of workloads be performed multiple times using different inputs. In such instances, steps 730-740 may be omitted and previously cached domain-specific instructions may be used. In various embodiments, step 750 may still be performed.

Turning now to FIG. 8, another embodiment of a method for automatically deploying workloads in a computing platform is depicted. In one embodiment, platform 10 executes task runner 112 to perform method 800. In some embodiments, platform 10 executes task runner 112 on processor 110 by executing instructions produced by control program 113 as it interprets bytecode of task runner 112 at runtime. In the illustrated embodiment, method 800 includes steps 810-840. Method 800 may include additional (or fewer) steps in other embodiments. Various ones of steps 810-840 may be performed concurrently.

In step 810, task runner 112 receives a set of bytecode (e.g., bytecode 102) specifying a set of tasks (e.g., tasks 104). As noted above, in one embodiment, bytecode 102 may include calls to an API associated with task runner 112 to specify the tasks 104. For example, in one particular embodiment, a developer writes JAVA source code that specifies a plurality of tasks 104 by extending a base class defined within the API, where bytecode 102 is representative of the extended class. An instance of the extended class may then be provided to task runner 112 to perform tasks 104. In some embodiments, step 810 may be performed in a similar manner as step 710 described above.

In step 820, task runner 112 determines whether to offload the set of tasks to a coprocessor (e.g. processor 120). In one embodiment, task runner 112 (e.g., using determination unit 210) may analyze a JAVA .class file of the program to determine whether to offload tasks 104. In one embodiment, task runner 112 may make an initial determination based on a set of initial criteria. In some embodiments, if each of the initial criteria is satisfied, method 800 may proceed to step 830. In one embodiment, platform 10 may continue to determine whether to offload workloads, while step 830 is being performed, based on various additional criteria. In various embodiments, task runner 112's analysis may also be based, at least in part, on cache information for previously offloaded tasks 104. Task runner 112's determination may be based on any of the various criteria described above. In some embodiments, step 820 may be performed in similar manner as step 720 described above.

In step 830, task runner 112 causes generation of a set of instructions to perform the set of tasks. In one embodiment, task runner 112 causes generation of the set of instructions by generating a set of domain-specific instructions having a domain-specific language format and providing the set of domain-specific instructions to driver 116 to generate the set of instructions in the different format. For example, in one embodiment, task runner 112 may generate a set of OPENCL instructions and provide those instructions to driver 116. In one embodiment, driver 116 may, in turn, generate a set of instructions for the coprocessor (e.g., instructions within the ISA of the coprocessor). In one embodiment, task runner 112 may generate the set of domain-specific instructions by reifying the set of bytecode to produce an intermediary representation of the set of bytecode and converting the intermediary representation to produce the set of domain-specific instructions.

In step 840, task runner 112 causes the coprocessor to execute the set of instructions by causing the set of instructions to be provided to the coprocessor. In one embodiment, task runner 112 may cause the set of instructions to be provided to the coprocessor by providing driver 116 with the set of generated domain-specific instructions. Once the coprocessor executes the set of instructions provided by driver 116, the coprocessor, in one embodiment, may provide driver 116 with the results of executing the set of instructions. In one embodiment, task runner 112 converts the results back into datatypes supported by bytecode 102. In one embodiment, task runner 112 converts the results from OPENCL datatypes back into JAVA datatypes. In some embodiments, task runner 112 may prevent the garbage collector from reclaiming memory locations used to the store the generated results. Once the results have been converted, instructions of the program that use the converted results may be executed.

As with method 700, method 800 may be performed multiple times for bytecode of different received programs. Method 800 may also be repeated if the same program is received again or includes multiple instances of the same bytecode. If the same bytecode is received twice, various ones of steps 810-840 may be omitted. As noted above, in some embodiments, task runner 112 may cache information about previously offloaded tasks 104, such as information generated during steps 820-840. If bytecode is received again, task runner 112, in one embodiment, may perform a cursory determination to offload tasks 104 in step 820. Task runner 112 may then perform step 840 using previously cached domain-specific instructions instead of performing step 830.

Note that method 800 may be performed differently in other embodiments. In one embodiment, task runner 112 may receive a set of bytecode specifying a set of tasks (as in step 810). Task runner 112 may then cause generation of a set of instructions to perform the set of tasks (as in step 830) in response to determining to offload the set of tasks to the coprocessor, where the determining may be performed by software other than task runner 112. Task runner 112 may then cause the set of instructions to be provided to the coprocessor for execution (as in step 840). Thus, method 800 may not include step 820 in some embodiments.

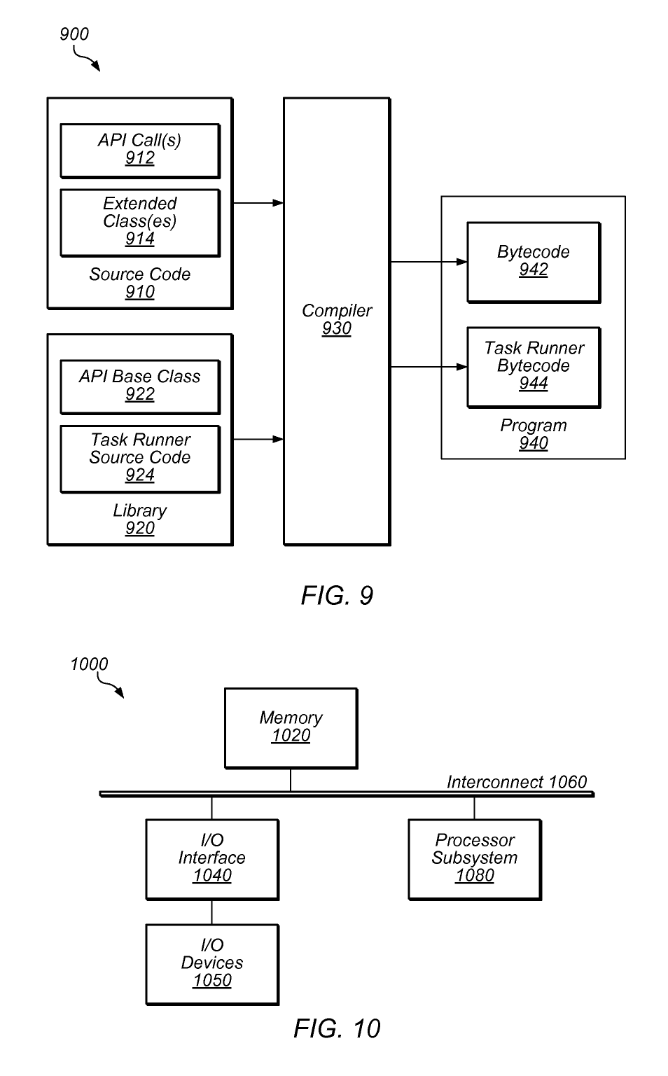

Turning now to FIG. 9, one embodiment of an exemplary compilation 900 of program instructions is depicted. In the illustrated embodiment, compiler 930 compiles sources code 910 and library 920 to produce program 940. In other embodiments, compilation 900 may include compiling additional pieces of source code and/or library source code. In some embodiments, compilation 900 may be performed differently depending upon the program language being used.

Source code 910, in one embodiment, is source code written by a developer to perform a data parallel problem. In the illustrated embodiment, source code 910 includes one or more API calls 912 to library 920 to specify one or more sets of tasks for parallelization. In one embodiment, an API call 912 specifies an extended class 914 of an API base class 922 defined within library 920 to represent the data parallel problem. Source code 910 may be written in any of a variety of languages, such as those described above.

Library 920, in one embodiment, is an API library for task runner 112 that includes API base class 922 and task runner source code 924. (Note that task runner source code 924 may be referred to herein as “library routine”). In one embodiment, API base class 922 includes library source code that is compilable along with source code 910 to produce bytecode 942. In various embodiments, API base class 922 may define one or more variables and/or one or more functions usable by source code 910. As noted above, API base class 922, in some embodiments, is a class that is extendable by a developer to produce one or more extended classes 914 to represent a data parallel problem. In one embodiment, task runner source code 924 is source code that is compilable to produce task runner bytecode 944. In some embodiments, task runner bytecode 944 may be unique to given set of bytecode 942. In another embodiment, task runner bytecode 944 may be usable with different sets of bytecode 942 that are compiled independently of task runner bytecode 944.

As noted above, compiler 930, in one embodiment, is executable to compile sources code 910 and library 920 to produce program 940. In one embodiment, compiler 930 produces program instructions that are to be executed by a processor (e.g. processor 110). In another embodiment, compiler produces program instructions that are to be interpreted to produce executable instructions at runtime. In one embodiment, source code 910 specifies the libraries (e.g., library 920) that are to be compiled with source code 910. Compiler 930 may then retrieve the library source code for those libraries and compile it with source code 910. Compiler 930 may support any of a variety of languages, such as described above.

Program 940, in one embodiment, is a compiled program that is executable by platform 10 (or interpretable by control program 113 executing on platform 10). In the illustrated embodiment, program 940 includes bytecode 942 and task runner bytecode 944. For example, in one embodiment, program 940 may correspond to a JAVA .jar file that includes respective .class files for bytecode 942 and bytecode 944. In other embodiments, bytecode 942 and bytecode 944 may correspond to separate programs 940. In various embodiments, bytecode 942 corresponds to bytecode 102 described above. (Note that bytecode 944 may be referred to herein as a “compiled library routine”).

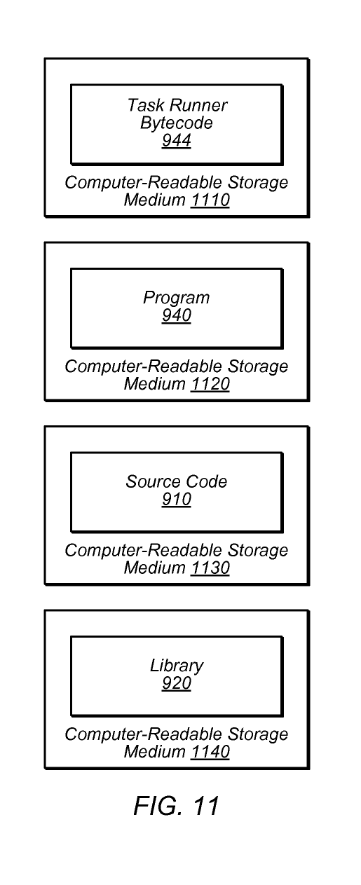

As will be described with reference to FIG. 11, various ones of elements 910-940 or portions of ones of elements 910-940 may be included on computer-readable storage media.

One example of possible source code that may be compiled by compiler 930 that uses library 920 to produce program 940 is presented below. In this example, an array of floats (values[ ]) is initialized with a set random values. The array is then is processed to determine, for a given element in the array, how many other elements in the same array fall with a predefined window (e.g., +/−2.0). The results of these determinations are then stored in respective locations within a corresponding integer array (counts[ ]).

To initialize values in the values in the array (values [ ]) the following code may be run:

int size = 1024*16;
final float width = 1.2f;
final float[ ] values = new float[size];
final float[ ] counts = new float[size];
// create random data
for (int i = 0; i < size; i++) {

values[i] = (float) Math.random( ) * 10f;

}

Traditionally, the above problem may be solved using the following code sequence:

for (int myId = 0; myId < size; myId++) {

int count = 0;
for (int i = 0; i < size; i++) {

if (values[i] > values[myId] − width && values[i] <

values[myId] + width) {

count++;

}

}
counts[myId] = (float) count;

}

In accordance with the present disclosure, the above problem may now be solved using the following code in one embodiment:

Task task = new Task( ){

public void run( ) {

int myId = getGlobalId(0);
int count = 0;
for (int 1 = 0; i < size; i++) {

if (values[i] > values[myId] − width && values[i] <

values[myId] + width) {

count++;

}

}
counts[myId] = (float) count;

}

}

This code extends the base class “Task” overriding the routine run( ) That is, the base class may include the method/function run( ) and the extended class may specify a preferred implementation of run ( ) for a set of tasks 104. In various embodiments, task runner 112 is provided the bytecode of this extended class (e.g., as bytecode 102) for automatic conversion and deployment. In various embodiments, if the method Task.run( ) is converted and deployed (i.e., offloaded), the method Task.run ( ) may not be executed, but rather the converted/deployed version of Task.run( ) is executed—e.g., by processor 120. If, however, Task.run( ) is not converted and deployed, Task.run( ) may be performed—e.g., by processor 110.

In one embodiment, the following code is executed to create an instance of task runner 112 to perform the tasks specified above. Note that the term “TaskRunner” corresponds to task runner 112.

TaskRunner taskRunner = new TaskRunner(task);
taskRunner.execute(size, 16);

The first line creates an instance of task runner 112 and provides task runner 112 with an instance of the extended base class “task” as input.

In one embodiment, task runner 112 may produce the following OPENCL instructions when task runner 112 is executed:

_{——}kernel void run(

_{——}global float *values,
_{——}global int *counts

){

int myId=get_global_id(0);
int count=0;
for(int i=0; i<16384; i++){

if(values[i]>values[myId]−1.2f){

if(values[i]<values[myId]+1.2f){

count++;

}

}

}
counts[myId] = counts[myId]+1;
return;

}

As described above, in some embodiments, this code may be provided to driver 116 to generate a set of instruction for processor 120.

### Exemplary Computer System

Turning now to FIG. 10, one embodiment of an exemplary computer system 1000, which may implement platform 10, is depicted. Computer system 1000 includes a processor subsystem 1080 that is coupled to a system memory 1020 and I/O interfaces(s) 1040 via an interconnect 1060 (e.g., a system bus). I/O interface(s) 1040 is coupled to one or more I/O devices 1050. Computer system 1000 may be any of various types of devices, including, but not limited to, a server system, personal computer system, desktop computer, laptop or notebook computer, mainframe computer system, handheld computer, workstation, network computer, a consumer device such as a mobile phone, pager, or personal data assistant (PDA). Computer system 1000 may also be any type of networked peripheral device such as storage devices, switches, modems, routers, etc. Although a single computer system 1000 is shown in FIG. 10 for convenience, system 1000 may also be implemented as two or more computer systems operating together.

Processor subsystem 1080 may include one or more processors or processing units. For example, processor subsystem 1080 may include one or more processing elements that are coupled to one or more resource control processing elements 1020. In various embodiments of computer system 1000, multiple instances of processor subsystem 1080 may be coupled to interconnect 1060. In various embodiments, processor subsystem 1080 (or each processor unit within 1080) may contain a cache or other form of on-board memory. In one embodiment, processor subsystem 1080 may include processor 110 and processor 120 described above.

System memory 1020 is usable by processor subsystem 1080. System memory 1020 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 1000 is not limited to primary storage such as memory 1020. Rather, computer system 1000 may also include other forms of storage such as cache memory in processor subsystem 1080 and secondary storage on I/O Devices 1050 (e.g., a hard drive, storage array, etc.). In some embodiments, these other forms of storage may also store program instructions executable by processor subsystem 1080. In some embodiments, memory 100 described above may include (or be included within) system memory 1020.

I/O interfaces 1040 may be any of various types of interfaces configured to couple to and communicate with other devices, according to various embodiments. In one embodiment, I/O interface 1040 is a bridge chip (e.g., Southbridge) from a front-side to one or more back-side buses. I/O interfaces 1040 may be coupled to one or more I/O devices 1050 via one or more corresponding buses or other interfaces. Examples of I/O devices include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1000 is coupled to a network via a network interface device.

### Exemplary Computer-Readable Storage Media

Turning now to FIG. 11, embodiments of exemplary computer readable storage media 1110-1140 are depicted. Computer-readable storage media 1100-1140 are embodiments of an article of manufacture that stores instructions that are executable by platform 10 (or interpretable by control program 113 executing on platform 10). As shown, computer-readable storage medium 1110 includes task runner bytecode 944. Computer-readable storage medium 1120 includes program 940. Computer-readable storage medium 1130 includes source code 910. Computer-readable storage medium 1140 includes library 920. FIG. 11 is not intended to limit the scope of possible computer-readable storage media that may be used in accordance with platform 10, but rather to illustrate exemplary contents of such media. In short, computer-readable media may store any of a variety of program instructions and/or data to perform operations described herein.

Computer-readable storage media 1110-1140 refer to any of a variety of tangible (i.e., non-transitory) media that store program instructions and/or data used during execution. In one embodiment, ones of computer-storage readable media 1100-1140 may include various portions of the memory subsystem 1710. In other embodiments, ones of computer-readable storage media 1100-1140 may include storage media or memory media of a peripheral storage device 1020 such as magnetic (e.g., disk) or optical media (e.g., CD, DVD, and related technologies, etc.). Computer-readable storage media 1110-1140 may be either volatile or nonvolatile memory. For example, ones of computer-readable storage media 1110-1140 may be (without limitation) FB-DIMM, DDR/DDR2/DDR3/DDR4 SDRAM, RDRAM®, flash memory, and of various types of ROM, etc. Note: as used herein, a computer-readable storage medium is not used to connote only a transitory medium such as a carrier wave, but rather refers to some non-transitory medium such as those enumerated above.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A computer-readable storage medium having program instructions stored thereon that are executable on a first processor of a computer system to perform:
receiving a first set of bytecode, wherein the first set of bytecode specifies a first set of tasks;
in response to determining to offload the first set of tasks to a second processor of the computer system, causing generation of a set of instructions to perform the first set of tasks, wherein the set of instructions are in a format different from that of the first set of bytecode, wherein the format is supported by the second processor; and
causing the set of instructions to be provided to the second processor for execution.

2. The computer-readable storage medium of claim 1, wherein the program instructions are interpretable by a control program on the first processor to produce instructions within an instruction set architecture (ISA) of the first processor.

3. The computer-readable storage medium of claim 2, wherein the program instructions are further interpretable by the control program to perform:
receiving a second set of bytecode, wherein the second set of bytecode specifies a second set of tasks; and
in response to determining to not offload the second set of tasks to the second processor, causing the control program to interpret the second set of bytecode to produce instructions within the ISA of the first processor, wherein the first processor is configured to perform the second set of tasks by executing the instructions produced by interpretation of the second set of bytecode.

4. The computer-readable storage medium of claim 3, wherein the program instructions are further interpretable by the control program to perform:
in response to determining to not offload the second set of tasks to the second processor, generating a corresponding set of bytecode that is interpretable by the control program to create a thread pool that includes a thread for each of a plurality of tasks within the second set of tasks; and
causing the control program to interpret the corresponding set of bytecode to produce instructions within the ISA of the first processor, wherein the first processor is configured to perform the second set of tasks by executing the instructions produced from the corresponding set of bytecode.

5. The computer-readable storage medium of claim 2, wherein the control program is executable to implement a virtual machine.

6. The computer-readable storage medium of claim 1, wherein causing the automatic generation of the set of instructions in the different format includes:
generating a set of domain-specific instructions having a domain-specific language format;
providing the set of domain-specific instructions to a driver of the second processor that is executable to generate the set of instructions in the different format.

7. The computer-readable storage medium of claim 6, wherein generating the set of instructions having the domain-specific language format includes:
reifying the first set of bytecode to produce an intermediary representation of the first set of bytecode; and
converting the intermediary representation of the first set of bytecode to produce the set of domain-specific instructions.

8. The computer-readable storage medium of claim 6, wherein the program instructions are executable to perform:
storing the set of domain-specific instructions;
receiving the first set of bytecode again;
in response to determining that the set of domain-specific instructions is stored, providing the stored set of domain-specific instructions to the driver of the second processor to cause generation of the set of instructions to perform the first set of tasks.

9. The computer-readable storage medium of claim 1, wherein the determining is based on analysis of previous executions of the first set of tasks by the first processor and by the second processor.

10. The computer-readable storage medium of claim 9, wherein the first processor uses a thread pool to perform one of the previous executions of the first set of tasks.

11. The computer-readable storage medium of claim 1, wherein the program instructions are further executable to perform:
before the second processor executes the set of instructions, reserving a set of memory locations to store a set of results for the first set of tasks;
preventing a garbage collector from reallocating the set of memory locations while the second processor is producing the set of results; and
storing the set of results in the set of memory locations.

12. The computer-readable storage medium of claim 1, wherein the first set of bytecode specifies the first set of tasks by including one or more calls to an application programming interface.

13. The computer-readable storage medium of claim 1, wherein the second processor is a graphics processor.

14. A computer-readable storage medium, comprising:
source program instructions that are compilable by a compiler for inclusion in compiled code as compiled source code;
wherein the source program instructions include an application programming interface (API) call to a library routine, wherein the API call specifies a set of tasks, and wherein the library routine is compilable by the compiler for inclusion in the compiled code as a compiled library routine;
wherein the compiled source code is interpretable by a virtual machine of a first processor of a computing system to pass the set of tasks to the compiled library routine; and
wherein the compiled library routine is interpretable by the virtual machine to:
in response to determining to offload the set of tasks to a second processor of the computing system, cause generation of a set of domain-specific instructions in a domain-specific language format of the second processor;
cause the set of domain-specific instructions to be provided to the second processor.

15. The computer-readable storage medium of claim 14, wherein the second processor is a graphics processor, and wherein generation of the set of domain-specific instructions includes reifying the compiled source code.

16. The computer-readable storage medium of claim 14, wherein the API call specifies an extended class of a base class associated with the library routine.

17. A computer-readable storage medium, comprising:
source program instructions of a library routine that are compilable by a compiler for inclusion in compiled code as a compiled library routine;
wherein the compiled library routine is executable on a first processor of a computer system to perform:
receiving a first set of bytecode, wherein the first set of bytecode specifies a set of tasks;
in response to determining to offload the set of tasks to a second processor of the computer system, generating a set of domain-specific instructions to perform the set of tasks;
causing the domain-specific instructions to be provided to the second processor for execution.

18. The computer-readable storage medium of claim 17, wherein the compiled library routine is interpretable by a virtual machine for the first processor, wherein the virtual machine is executable to interpret compiled instructions to produce instructions within an instruction set architecture (ISA) of the first processor.

19. A method, comprising:
receiving a first set of instructions, wherein the first set of instructions specifies a set of tasks, and wherein the receiving is performed by a library routine executing on a first processor of a computer system;
the library routine determining whether to offload the set of tasks to a second processor of the computer system;
in response to determining to offload the set of tasks to the second processor, causing generation of a second set of instructions to perform the first set of tasks, wherein the second set of instructions are in a format different from that of the first set of instructions, wherein the format is supported by the second processor;
causing the second set of instructions to be provided to the second processor for execution.

20. The method of claim 19, wherein the routine is interpretable by a virtual machine executable to produce instructions within an instruction set architecture (ISA) of the first processor, and wherein the second processor is a graphics processor.

21. A method, comprising:
a computer system receiving a first set of bytecode specifying a set of tasks;
in response to determining to offload the set of tasks from a first processor of the computer system to a second processor of the computer system, the computer system generating a set of domain-specific instructions to perform the set of tasks; and
the computer system causing the domain-specific instructions to be provided to the second processor for execution.

22. The computer-readable storage medium of claim 21, wherein said generating is performed by a compiled library routine that is interpretable by a virtual machine for the first processor, wherein the virtual machine is executable to interpret compiled instructions to produce instructions within an instruction set architecture (ISA) of the first processor.
